(19) United States
(12) Patent Application Publication
(10) Pub. No.: US 2008/0005943 A1
(43) Pub. Date: Jan. 10, 2008

(54) Solar powered illuminated sign having at least one interchangeable character

(76) Inventors: Albert Chao, Saddle River, NJ (US); Ethel Chao, Saddle River, NJ (US)

Correspondence Address: RICHARD L. MILLER, 12 PARKSIDE DRIVE, DIX HILLS, NY, 11746, US

(21) Appl. No.: 11/481,301

(22) Filed: Jul. 5, 2006

(51) Int. Cl. G09F 13/22

(52) U.S. Cl. 40/544

(57) ABSTRACT

A solar powered illuminated sign having at least one interchangable character which comprises a transparent panel mounted centrally across a front wall of a housing. A mechanism is for mounting a character display medium in a removable manner over the transparent panel. A control circuit, a rechargeable battery and a light source are within said housing. The rechargeable battery and the light source are electrically connected to the control circuit. A solar generating unit is mounted onto the front wall of the housing, wherein the solar generating unit is electrically connected to the control circuit. In a first instance during daylight hours, the sun will supply solar energy to the solar generating unit, causing the control circuit to allow charging of the rechargeable battery and deactivate the light source. In a second instance during nighttime hours, the control circuit will allow the rechargeable battery to supply DC electric power to the light source, to illuminate the transparent panel and the character display medium.

### BACKGROUND OF THE INVENTION

1. Field of the Invention

The present invention relates to a solar sign, and more particularly, a solar powered illuminated sign having at least one interchangable character.

2. Description of the Prior Art

An innovation for a lighting display system has been provided in the prior art that will be described. Even though this innovation may be suitable for the specific individual purposes to which it addresses, however, it differs from the present invention.

An EXAMPLE, U.S. Pat. No. 4,028,828 issued on Jun. 14, 1977 to Chao, et al. teaches a novel lighting display system for numerous uses consisting of the following members. A mounting board containing two channels across the boards length, each channel carrying one electrical conductor; and plastic numerals, letters, or other characters, which when inserted into the boards channels are securely attached to the board, come in contact with electrical conductors in the channels and become illuminated. The plastic characters are constructed by encasing miniature light bulbs, mounted in a parallel electrical circuit on a printed circuit board, in a plastic material. Various characters can be combined to form an illuminated message, word, or series of numerals.

It is apparent now that the innovation for a lighting display system has been provided in the prior art that is adequate for various purposes. Furthermore, even though this innovation may be suitable for the specific individual purposes to which it addresses, accordingly, it would not be suitable for the purposes of the present invention as heretofore described.

### SUMMARY OF THE INVENTION

AN OBJECT of the present invention is to provide a solar powered illuminated sign having at least one interchangable character that avoids the disadvantages of the prior art.

ANOTHER OBJECT of the present invention is to provide a solar powered illuminated sign having at least one interchangable character that is simple and inexpensive to manufacture.

STILL ANOTHER OBJECT of the present invention is to provide a solar powered illuminated sign having at least one interchangable character that is simple to use.

BRIEFLY STATED, STILL YET AIOTHER OBJECT of the present invention is to provide a solar powered illuminated sign having at least one interchangable character which comprises a transparent panel mounted centrally across a front wall of a housing. A mechanism is for mounting a character display medium in a removable manner over the transparent panel. A control circuit, a rechargeable battery and a light source are within the housing. The rechargeable battery and the light source are electrically connected to the control circuit. A solar generating unit is mounted onto the front wall of the housing, wherein the solar generating unit is electrically connected to the control circuit. In a first instance during daylight hours, the sun will supply solar energy to the solar generating unit causing the control circuit to allow charging of the rechargeable battery and deactivate the light source. In a second instance during nighttime hours, the control circuit will allow the rechargeable battery to supply DC electric power to the light source to illuminate the transparent panel and the character display medium.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a diagrammatic perspective view showing a first embodiment of the present invention in use mounted to a side wall of a mailbox;

FIG. 2 is an enlarged diagrammatic perspective view of the first embodiment utilized for holding a single character display medium taken in the direction of arrow 2 in FIG. 1;

FIG. 3 is a cross sectional view taken on line 3-3 in FIG. 2;

FIG. 4 is an enlarged diagrammatic perspective view of the first embodiment utilized for holding two character display mediums;

FIG. 5 is an enlarged diagrammatic perspective view of the first embodiment similar to FIG. 4 showing a single character display medium installed instead of the two character display mediums;

FIG. 6 is an enlarged diagrammatic perspective view of the first embodiment utilized for holding three character display mediums;

FIG. 7 is a diagrammatic block diagram of the electrical system of the present invention;

FIG. 8 is a diagrammatic perspective view showing a second embodiment of the present invention, which has character display mediums on both sides, in use mounted onto the top of the mailbox;

FIG. 9 is an enlarged diagrammatic cross sectional view taken on line 9- 9 in FIG. 8; and

FIG. 10 is a diagrammatic perspective view of a third embodiment, in which the housing is separated into two segments.

### A MARSHALLING OF REFERENCE FNUERALS UTILIZED IN THE DRAWING

### FIRST EMBODIMENT

20 solar powered illuminated sign
22 housing of sign 20
24 transparent panel of sign 20
26 front wall of housing 22
28 character display medium of sign 20
30 mounting mechanism of sign 20
32 control circuit of sign 20
34 rechargeable battery of sign 20
36 light source of sign 20
38 solar generating unit of sign 20
40 sun
42 white reflector of sign 20
44 centrally recessed area on front wall 26
46 flat transparent plate of character display medium 28
48 embossed transparent charter on plate 46
50 front surface of plate 46
52 black coating on rear surface 54
54 rear surface of plate 46
56 first track of mounting mechanism 30
58 second track of mounting mechanism 30
60 LED (Light Emitting Diode) for light source 36
62 solar cell of solar generating unit 38
64 black panel for sign 20

### SECOND EMBODIMENT

20A solar powered illuminated sign
22A housing of sign 20A
24A second mounting mechanism of sign 20A
27A rear wall of housing 22A
30A second mounting mechanism of sign 20A
36A second light source of sign 20A
38A second solar generating unit of sign 20A
42A second white reflector of sign 20A
44A second centrally recessed area on rear wall 27A

### THIRD EMBODIMENT

20B solar powered illuminated sign
22B housing of sign 20B
23B first segment of housing 22B
24B transparent panel of sign 20B
25B second segment of housing 22B
26B front wall of first segment 23B
28B character display medium of sign 20B
30B mounting mechanism of sign 20B
32B control circuit of sign 20B
34B rechargeable battery of sign 20B
36B light source of sign 20B
38B solar generating unit of sign 20B
39B front wall of second segment 25B
41B electrically connecting component of sign 20B
42B white reflector of sign 20B
44B centrally recessed area on front wall 26B
66B first socket in first segment 23B
68B second socket in second segment 25B
70B elongated cable of component 41B
72B first plug on cable 70B
74B second plug on cable 70B
76B first socket in first segment 23B
78B second socket in first segment 23B
80B first plug on second segment 25B
82B second plug on second segment 25B

### DETAILED DESCRIPTION OF THE PREFERRED EMBODIMENT

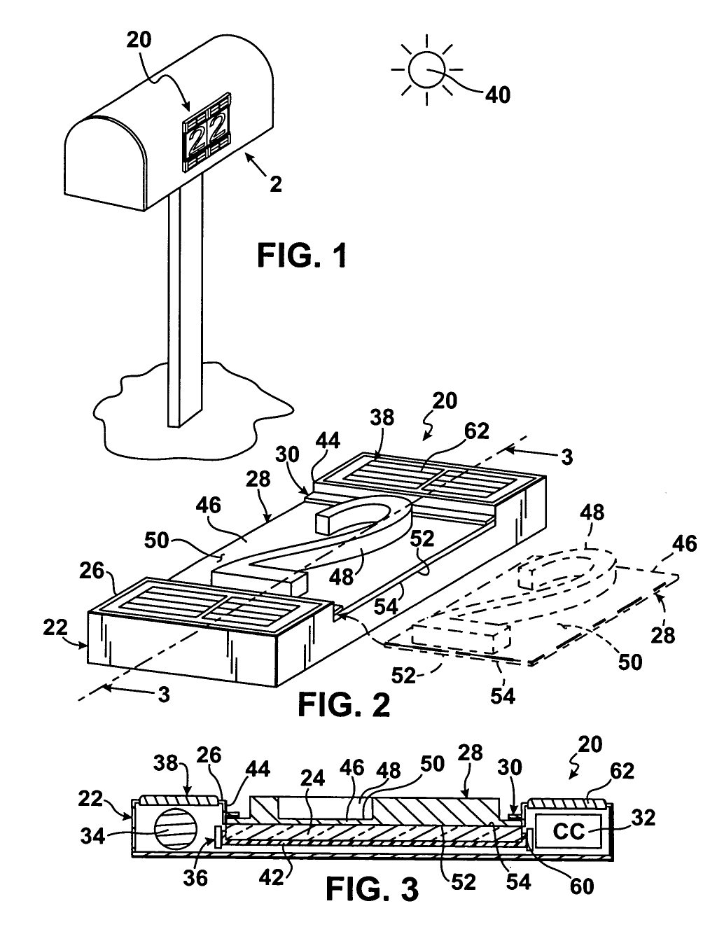

Referring now to the figures, in which like numerals indicate like parts, and particularly to FIGS. 1, 2, 3 and 6, in which the first embodiment of the present invention is illustrated, and as such, will be discussed with reference thereto.

The first embodiment is a solar powered illuminated sign 20 having at least one interchangable character which comprises a housing 22. A transparent panel 24 is mounted centrally across a front wall 26 of the housing 22. A character display medium 28 is also provided. A mechanism 30 is for mounting the character display medium 28 in a removable manner over the transparent panel 24. A control circuit 32 is within the housing 22. A rechargeable battery 34 is within the housing 22, wherein the rechargeable battery 34 is electrically connected to the control circuit 32. A light source 36 is within the housing 22, wherein the light source 36 is electrically connected to control circuit 32. A solar generating unit 38 is mounted onto the front wall 26 of the housing 22, wherein the solar generating unit 38 is electrically connected to the control circuit 32.

In a first instance during daylight hours, the sun 40 will supply solar energy to the solar generating unit 38, causing the control circuit 32 to allow charging of the rechargeable battery 34 and deactivate the light source 36. In a second instance during nighttime hours, the control circuit 32 will allow the rechargeable battery 34 to supply DC electric power to the light source 36, to illuminate the transparent panel 24 and the character display medium 28.

A white reflector 42 is mounted behind the transparent panel 24, to produce a high lumen output with low voltage DC power supplied by the rechargeable battery 34 to the light source 36. The housing 22 has a centrally recessed area 44 extending across the front wall 26, with the transparent panel 24 mounted within the centrally recessed area 44.

The character display medium 28 further comprises a flat transparent plate 46, having an embossed transparent character 48 on a front surface 50. A black coating 52 is applied to rear surface 54 of the flat transparent plate 46, leaving a clear area of the embossed transparent character 48 above on the front surface 50.

The mounting mechanism 30 comprises a pair of tracks 56, 58. The first track 56 is affixed to and extends inwardly over top of the centrally recessed area 44 of the housing 22. The second track 58 is affixed to and extends inwardly over bottom of said centrally recessed area 44 of the housing 22. The flat transparent plate 46 of the character display medium 28 can be inserted into and removed from the tracks 56, 58 in the centrally recessed area 44 of the housing 22.

The light source 36 comprises at least one LED (Light Emitting Diode) 60, in which the at least one LED 60 abuts one side edge of the transparent panel 24. The solar generating unit 38 comprises a plurality of solar cells 62.

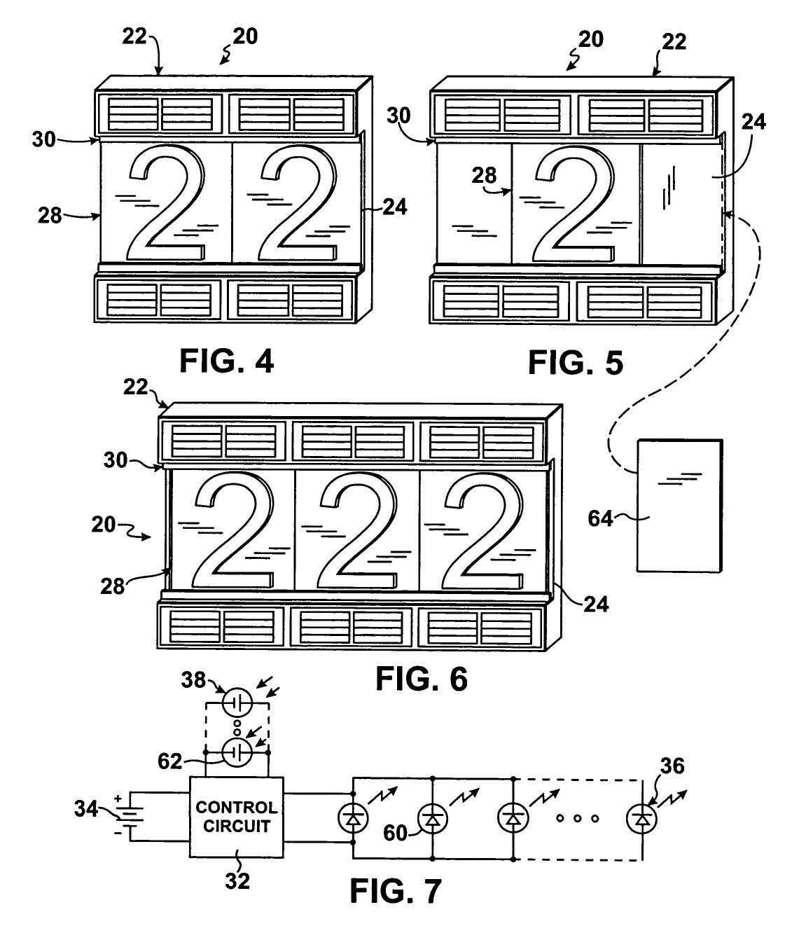

The sign 20 as shown in FIG. 4, further comprises the housing 22 having a width to accommodate two character display mediums 28 that are held in a side by side relationship by mounting mechanism 38 over the transparent panel 24, having the same width as the housing 22.

The sign 20 as shown in FIG. 5, is identical to the sign 20 in FIG. 4, but further comprises two black panels 64. When only one character display medium 28 is used, each black panel 64 can be held by the mounting mechanism 30 on an opposite side of the character display medium 28 over the transparent panel 24.

The sign 20 as shown in FIG. 6, further comprises the housing 22 having a width to accommodate three character display mediums 28 that are held in a side by side relationship by said mounting means 30 over the transparent panel 24, having the same width as the housing 22.

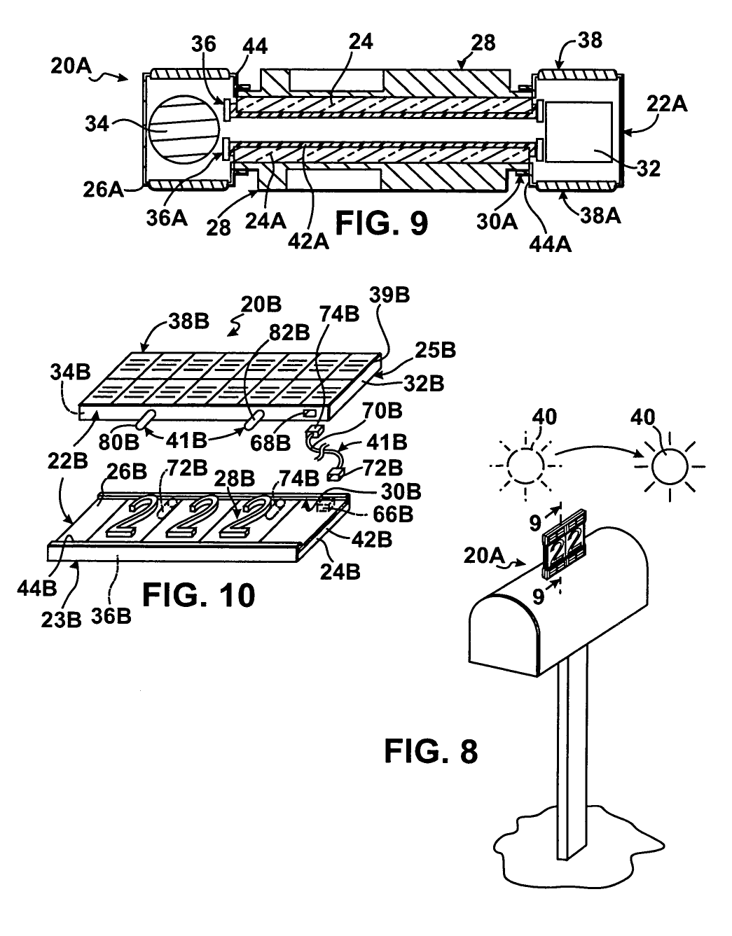

FIGS. 8 and 9 show a second embodiment of the present invention, and as such, will be discussed with reference thereto. The second embodiment is a sign 20A that is like the sign 20, except that it comprises a second transparent panel 24A mounted centrally across a rear wall 27A of the housing 22A. A second character display medium 28 is provided. A second mechanism 30A is for mounting the second character display medium 28 in a removable manner over the second transparent panel 24A. A second light source 36A is within the housing 22A, wherein the second light source 36A is electrically connected to the control circuit 32. A second solar generating unit 38A is mounted onto the rear wall 27A of the housing 22A, wherein the second solar generating unit 38A is electrically connected to control circuit 32.

In a first instance during daylight hours, the sun 40 will supply solar energy to the first and second solar generating units 38, 38A, causing the control circuit 32 to allow charging of the rechargeable battery 34 and deactivate the first and second light sources 36, 36A. In a second instance during nighttime hours, the control circuit 32 will allow the rechargeable battery 34 to supply DC electric power to the first and second light sources 36, 36A, to illuminate the first and second transparent panels 24, 24A and the first and second display medium 28.

A second white reflector 42A is mounted behind the second transparent panel 24A, to produce a high lumen output with low voltage DC power supplied by the rechargeable battery 24 to the second light source 36A. The housing 22A has a second centrally recessed area 44A extending across the rear wall 26A with the second transparent panel 24A mounted within the second centrally recessed area 44A. The second character display medium 28A, the second mounting mechanism 30A, the second light source 36A and the second solar generating unit 36A are identical to their respective elements shown in the sign 20.

FIG. 10 shows a third embodiment of the present invention, and as such, will be discussed with reference thereto. The third embodiment is a solar powered illuminated sign 20B having at least one interchangable character that comprises a housing 22B separated into two segments 23B, 25B. A transparent panel 24B is mounted centrally across a front wall 26B of the first segment 23B of the housing 22B. At least one character display medium 28B is provided. A mechanism 30B is for mounting at least one character display medium 28B in a removable manner over the transparent panel 24B. A control circuit 32B is within the second segment 25B of the housing 22B. A rechargeable battery 34B is within the second segment 25B of housing 22B, wherein the rechargeable battery 34B is electrically connected to the control circuit 32B. A light source 36B is within the first segment 23B of the housing 22B. A solar generating unit 38B is mounted onto a front wall 39B of the second segment 25B of the housing 22B, wherein the solar generating unit 38B is electrically connected to the control circuit 32B.

A component 41B is for electrically connecting the light source 36B within the first segment 23B of the housing 22B to the control circuit 32B within the second segment 25B of the housing 22B. In a first instance during daylight hours, the sun 42 will supply solar energy to the solar generating unit 38B, causing the control circuit 32B to allow charging of the rechargeable battery 34B and deactivate the light source 36B. In a second instance during nighttime hours, the control circuit 32B will allow the rechargeable battery 34B to supply DC electric power to the light source 36B to illuminate the transparent panel 24B and the at least one character display medium 28B.

A white reflector 42B is mounted behind the transparent panel 24B to produce a high lumen output with low voltage DC power supplied by the rechargeable battery 34B to the light source 36B. The first segment 23B of the housing 22B has a centrally recessed area 44B extending across the front wall 26B with the transparent panel 24B mounted within the centrally recessed area 44B. The at least one character display medium 28B, the mounting mechanism 30B, the light source 36B and the solar generating unit 38 are identical to the respective elements shown in the sign 20.

The electrically connecting component 41B can comprise a first socket 66B in the first segment 23B of the housing 22B, wherein the first socket 66B is electrically connected to the light source 36B. A second socket 68B is in the second segment 25B of the housing 22B, wherein the second socket 68B is electrically connected to the control circuit 32B. An elongated cable 70B and a pair of plugs 72B, 74B are provided. Each plug 72B, 74B is connected to opposite end of the cable 70B, so that so that the first plug 72B can engage with the first socket 66B in the first segment 23B of the housing 22B, while the second plug 74B can engage with the second socket 68B in the second segment 25B of the housing 22B, thereby keeping the first segment 23B of the housing 22B remote from the second segment 25B of the housing 22B.

The electrically connecting component 41B can also comprise a pair of sockets 76B, 78B in the first segment 23B of the housing 22B, wherein the pair of sockets 76B, 78B are electrically connected to the light source 36B. A pair of plugs 80B, 82B are on the second segment 25B of the housing 22B, wherein the pair of plugs 80B, 82B are electrically connected to the control circuit 32B. The pair of plugs 80B, 82B can engage with the pair of sockets 76B, 78B, thereby keeping the first segment 23B of the housing 22B and the second segment 25B of the housing 22B together.

It will be understood that each of the elements described above, or two or more together, may also find a useful application in other types of constructions differing from the types described above.

While the invention has been illustrated and described as embodiments of a solar powered illuminated sign having at least one interchangable character, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

1. A solar powered illuminated sign having at least one interchangable character which comprises:
a) a housing;
b) a transparent panel mounted centrally across a front wall of said housing;
c) a character display medium;
d) means for mounting said character display medium in a removable manner over said transparent panel;
e) a control circuit within said housing;
f) a rechargeable battery within said housing, wherein said rechargeable battery is electrically connected to said control circuit;
g) a light source within said housing, wherein said light source is electrically connected to said control circuit; and
h) a solar generating unit mounted onto said front wall of said housing, wherein said solar generating unit is electrically connected to said control circuit, so that in a first instance during daylight hours, the sun will supply solar energy to said solar generating unit causing said control circuit to allow charging of said rechargeable battery and deactivate said light source, while in a second instance during nighttime hours, said control circuit will allow said rechargeable battery to supply DC electric power to said light source to illuminate said transparent panel and said character display medium.

2. The sign as recited in claim 1, further comprising a white reflector mounted behind said transparent panel to produce a high lumen output with low voltage DC power supplied by said rechargeable battery to said light source.

3. The sign as recited in claim 2, further comprising said housing having a centrally recessed area extending across said front wall with said transparent panel mounted within said centrally recessed area.

4. The sign as recited in claim 3, wherein said character display medium further comprises:
a) a flat transparent plate having an embossed transparent character on a front surface; and
b) a black coating applied to rear surface of said flat transparent plate leaving a clear area of said embossed transparent character above on said front surface.

5. The sign as recited in claim 4, wherein said mounting means comprises a pair of tracks, wherein said first track is affixed to and extends inwardly over top of said centrally recessed area of said housing, while said second track is affixed to and extends inwardly over bottom of said centrally recessed area of said housing, thereby said flat transparent plate of said character display medium can be inserted into and removed from said tracks in said centrally recessed area of said housing.

6. The sign as recited in claim 1, wherein said light source comprises at least one LED, in which said at least one LED abuts one side edge of said transparent panel.

7. The sign as recited in claim 1, wherein said solar generating unit comprises a plurality of solar cells.

8. The sign as recited in claim 2, further comprising said housing having a width to accommodate two character display mediums that are held in a side by side relationship by said mounting means over said transparent panel having the same width as said housing.

9. The sign as recited in claim 8, further comprising two black panels, wherein when only one said character display medium is used, each said black panel can be held by said mounting means on an opposite side of said character display medium over said transparent panel.

10. The sign as recited in claim 2, further comprising said housing having a width to accommodate three character display mediums that are held in a side by side relationship by said mounting means over said transparent panel, having the same width as said housing.

11. The sign as recited in claim 2, further comprising:
a) a second transparent panel mounted centrally across a rear wall of said housing;
b) a second character display medium;
c) second means for mounting said second character display medium in a removable manner over said second transparent panel;
d) a second light source within said housing, wherein said second light source is electrically connected to said control circuit; and
e) a second solar generating unit mounted onto said rear wall of said housing, wherein said second solar generating circuit is electrically connected to said control circuit, so that in a first instance during daylight hours, the sun will supply solar energy to said first and second solar generating units causing said control circuit to allow charging of said rechargeable battery and deactivate said first and second light sources, while in a second instance during nighttime hours, said control circuit will allow said rechargeable battery to supply DC electric power to said first and second light sources to illuminate said first and second transparent panels and said first and second display mediums.

12. The sign as recited in claim 11, further comprising a second white reflector mounted behind said second transparent panel to produce a high lumen output with low voltage DC power supplied by said rechargeable battery to said second light source.

13. The sign as recited in claim 12, further comprising said housing having a second centrally recessed area extending across said rear wall with said second transparent panel mounted within said second centrally recessed area.

14. The sign as recited in claim 13, wherein said second character display medium further comprises:
a) a flat transparent plate having an embossed transparent character on a front surface; and
b) a black coating applied to rear surface of said flat transparent plate leaving a clear area of said embossed transparent character above on said front surface.

15. The sign as recited in claim 14, wherein said second mounting means comprises a pair of tracks, wherein said first track is affixed to and extends inwardly over top of said second centrally recessed area of said housing, while said second track is affixed to and extends inwardly over bottom of said second centrally recessed area of said housing, thereby said flat transparent plate can be inserted into and removed from said tracks in said second centrally recessed area of said housing.

16. The sign as recited in claim 11, wherein said second light source comprises at least one LED, in which said at least one LED abuts one side edge of said second transparent panel.

17. The sign as recited in claim 11, wherein said second solar generating unit comprises a plurality of solar cells.

18. A solar powered illuminated sign having at least one interchangable character which comprises:
a) a housing separated into two segments;
b) a transparent panel mounted centrally across a front wall of said first segment of said housing;
c) at least one character display medium;
d) means for mounting said at least one character display medium in a removable manner over said transparent panel;
e) a control circuit within said second segment of said housing;
f) a rechargeable battery within said second segment of said housing, wherein said rechargeable battery is electrically connected to said control circuit;
g) a light source within said first segment of said housing;
h) a solar generating unit mounted onto a front wall of said second segment of said housing, wherein said solar generating unit is electrically connected to said control circuit;
i) means for electrically connecting said light source within said first segment of said housing to said control circuit within said second segment of said housing, so that in a first instance during daylight hours, the sun will supply solar energy to said solar generating unit causing said control circuit to allow charging of said rechargeable battery and deactivate said light source, while in a second instance during nighttime hours, said control circuit will allow said rechargeable battery to supply DC electric power to said light source to illuminate said transparent panel and said at least one character display medium.

19. The sign as recited in claim 18, further comprising a white reflector mounted behind said transparent panel to produce a high lumen output with low voltage DC power supplied by said rechargeable battery to said light source.

20. The sign as recited in claim 19, further comprising said first segment of said housing having a centrally recessed area extending across said front wall with said transparent panel mounted within said centrally recessed area.

21. The sign as recited in claim 20, wherein said at least one character display medium further comprises:
a) a flat transparent plate having an embossed transparent character on a front surface; and
b) a black coating applied to rear surface of said flat transparent plate leaving a clear area of said embossed transparent character above on said front surface.

22. The sign as recited in claim 21, wherein said mounting means comprises a pair of tracks, wherein said first track is affixed to and extends inwardly over top of said centrally recessed area of said first segment of said housing, while said second track is affixed to and extends inwardly over bottom of said centrally recessed area of said first segment of said housing, thereby said flat transparent plate of said at least one character display medium can be inserted into and removed from said tracks in said centrally recessed area of said first segment of said housing.

23. The sign as recited in claim 18, wherein said light source comprises at least one LED, in which said at least one LED abuts one side edge of said transparent panel.

24. The sign as recited in claim 18, wherein said solar generating unit comprises a plurality of solar cells.

25. The sign as recited in claim 18, wherein said electrically connecting means comprises:
a) a first socket in said first segment of said housing, wherein said first socket is electrically connected to said light source;
b) a second socket in said second segment of said housing, wherein said second socket is electrically connected to said control circuit;
c) an elongated cable; and
d) a pair of plugs, in which each said plug is electrically connected to an opposite end of said cable, so that said first plug can engage with said first socket in said first segment of said housing, while said second plug can engage with said second socket in said second segment of said housing, thereby keeping said first segment of said housing remote from said second segment of said housing.

26. The sign as recited in claim 18, wherein said electrically connecting means comprises:
a) a pair of sockets in said first segment of said housing, wherein said pair of sockets are electrically connected to said light source; and
b) a pair of plugs on said second segment of said housing, wherein said pair of plugs are electrically connected to said control circuit, so that said pair of
